(19) United States
(12) Patent Application Publication
(10) Pub. No.: US 2024/0311693 A1
(43) Pub. Date: Sep. 19, 2024

(54) SEQUENTIAL CUSTOMIZATION OF TEXT-TO-IMAGE DIFFUSION MODELS OR OTHER MACHINE LEARNING MODELS

(71) Applicant: Samsung Electronics Co., Ltd., Suwon-si (KR)

(72) Inventors: James S. Smith, Decatur, GA (US); Yen-Chang Hsu, Fremont, CA (US); Yilin Shen, Santa Clara, CA (US); Hongxia Jin, San Jose, CA (US); Lingyu Zhang, Cupertino, CA (US); Ting Hua, Santa Clara, CA (US)

(21) Appl. No.: 18/592,250

(22) Filed: Feb. 29, 2024

Related U.S. Application Data
(60) Provisional application No. 63/452,612, filed on Mar. 16, 2023.

(51) Int. Cl. G06N 20/00

(52) U.S. Cl. CPC G06N 20/00

(57) ABSTRACT

A method includes obtaining input data associated with a new concept to be learned by a trained machine learning model. The method also includes identifying initial weights of the trained machine learning model and one or more previous weight deltas associated with the trained machine learning model. The method further includes identifying one or more additional weight deltas based on the input data and guided by the initial weights and the one or more previous weight deltas. In addition, the method includes integrating the one or more additional weight deltas into the trained machine learning model. The one or more additional weight deltas are integrated into the trained machine learning model by identifying updated weights for the trained machine learning model based on the initial weights, the one or more previous weight deltas, and the one or more additional weight deltas.

### CROSS-REFERENCE TO RELATED APPLICATION AND PRIORITY CLAIM

This application claims priority under 35 U.S.C. § 119(e) to U.S. Provisional Patent Application No. 63/452,612 filed on Mar. 16, 2023, which is hereby incorporated by reference in its entirety.

### TECHNICAL FIELD

This disclosure relates generally to machine learning systems and processes. More specifically, this disclosure relates to sequential customization of text-to-image diffusion models or other machine learning models.

### BACKGROUND

Text-to-image generation is a rapidly-growing technology that aims to develop machine learning models capable of synthesizing high-quality images from textual descriptions. These machine learning models have the potential to enable a wide range of applications, such as generating realistic images (like for e-commerce websites), creating personalized avatars (like for extended reality environments), and aiding in artistic and creative endeavors. Recent advances have shown significant progress in generating images with fine-grain details that can be customized to specific concepts, such as generating a portrait of oneself or one's pet, while providing only a few example images to instruct the machine learning model.

### SUMMARY

This disclosure relates to sequential customization of text-to-image diffusion models or other machine learning models.

In a first embodiment, a method includes obtaining, using at least one processing device of an electronic device, input data associated with a new concept to be learned by a trained machine learning model. The method also includes identifying, using the at least one processing device, initial weights of the trained machine learning model and one or more previous weight deltas associated with the trained machine learning model. The method further includes identifying, using the at least one processing device, one or more additional weight deltas based on the input data and guided by the initial weights and the one or more previous weight deltas. In addition, the method includes integrating, using the at least one processing device, the one or more additional weight deltas into the trained machine learning model. The one or more additional weight deltas are integrated into the trained machine learning model by identifying updated weights for the trained machine learning model based on the initial weights, the one or more previous weight deltas, and the one or more additional weight deltas. In another embodiment, a non-transitory machine readable medium contains instructions that when executed cause at least one processor of an electronic device to perform the method of the first embodiment.

In a second embodiment, an electronic device includes at least one processing device configured to obtain input data associated with a new concept to be learned by a trained machine learning model. The at least one processing device is also configured to identify initial weights of the trained machine learning model and one or more previous weight deltas associated with the trained machine learning model. The at least one processing device is further configured to identify one or more additional weight deltas based on the input data and guided by the initial weights and the one or more previous weight deltas. In addition, the at least one processing device is configured to integrate the one or more additional weight deltas into the trained machine learning model. To integrate the one or more additional weight deltas into the trained machine learning model, the at least one processing device is configured to identify updated weights for the trained machine learning model based on the initial weights, the one or more previous weight deltas, and the one or more additional weight deltas.

In a third embodiment, a method includes obtaining, using at least one processing device of an electronic device, input data associated with a user request for a trained machine learning model. The method also includes identifying, using the at least one processing device, one or more customized tokens associated with the input data, where the one or more customized tokens are associated with one or more of multiple previous concepts learned by the trained machine learning model. The method further includes identifying, using the at least one processing device, key, value, and query features based on the input data and the one or more customized tokens. The method also includes performing, using the at least one processing device, key-value projection using the key features, the value features, and weights of the trained machine learning model to generate projected features. In addition, the method includes generating, using the at least one processing device, a response to the user request based on the query features and the projected features. The weights of the trained machine learning model are modified by sequentially teaching the trained machine learning model one or more new concepts over time. In another embodiment, an electronic device includes at least one processing device configured to perform the method of the third embodiment. In still another embodiment, a non-transitory machine readable medium contains instructions that when executed cause at least one processor of an electronic device to perform the method of the third embodiment.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another clement (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module.” “device.” “unit.” “component.” “clement.” “member.” “apparatus.” “machine.” “system.” “processor.” or “controller.” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example network configuration including an electronic device in accordance with this disclosure;

FIG. 2 illustrates an example architecture for sequential customization of a text-to-image diffusion model or other machine learning model in accordance with this disclosure;

FIG. 3 illustrates an example use of customized tokens during sequential customization of a text-to-image diffusion model or other machine learning model in accordance with this disclosure;

FIGS. 4A through 4D illustrate an example use case for sequential customization of a text-to-image diffusion model or other machine learning model in accordance with this disclosure;

FIG. 5 illustrates an example method for training a text-to-image diffusion model or other machine learning model during sequential customization in accordance with this disclosure; and

FIG. 6 illustrates an example method for using a text-to-image diffusion model or other machine learning model having learned during sequential customization in accordance with this disclosure.

### DETAILED DESCRIPTION

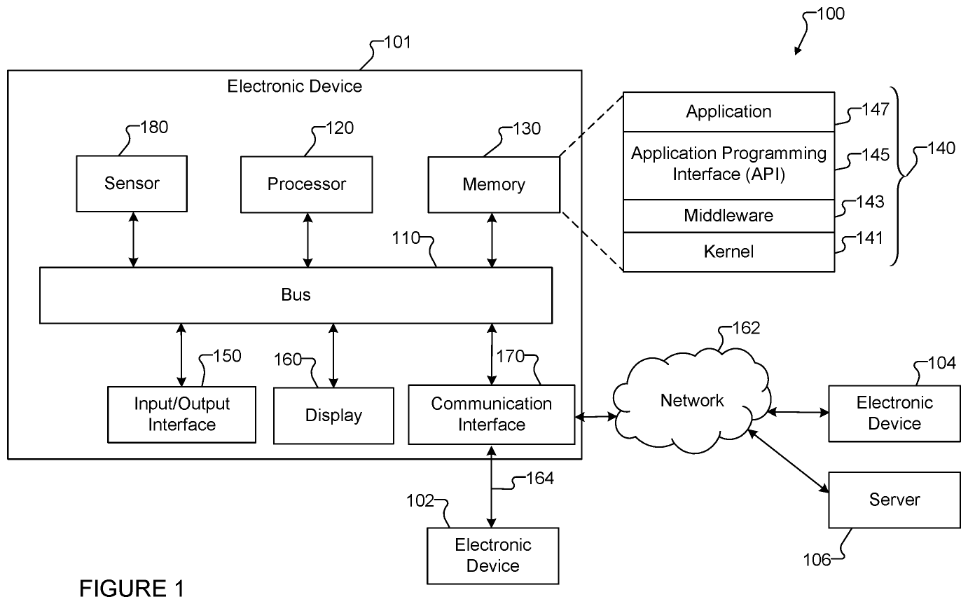

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, text-to-image generation is a rapidly-growing technology that aims to develop machine learning models capable of synthesizing high-quality images from textual descriptions. These machine learning models have the potential to enable a wide range of applications, such as generating realistic images (like for e-commerce websites), creating personalized avatars (like for extended reality environments), and aiding in artistic and creative endeavors. Recent advances have shown significant progress in generating images with fine-grain details that can be customized to specific concepts, such as generating a portrait of oneself or one's pet, while providing only a few example images to instruct the machine learning model.

Text-to-image generation machine learning models are typically trained using one or more training datasets and then deployed for use. Due to the wide variety of use cases of the machine learning models, it is routine for the machine learning models to receive requests related to concepts for which the machine learning models may not have been trained. This is a common problem not just for text-to-image generation machine learning models but for machine learning models in general. While some approaches have attempted to extend or customize machine learning models for new concepts, one problem that often arises in these approaches is “catastrophic forgetting.” Existing customization techniques for a text-to-image model or other machine learning model can suffer from catastrophic forgetting when new concepts arrive sequentially over the model's lifetime. More specifically, when adding a new concept, the ability to generate high-quality images or other outputs related to previously-learned similar concepts can degrade. As a result, the model can generate images or other outputs that are very different from the desired output distributions, such as when a generated image contains an incorrect person or other content or has observable image quality deterioration. While it is possible to simply retrain the machine learning model for the new concepts, this can be time-consuming and slow, can require storage of data related to the new concepts for lengthy periods of time, and can raise privacy concerns when the data related to the new concepts is sent from user devices to a remote destination for use during model training.

This disclosure provides various techniques for sequential customization of text-to-image diffusion models or other machine learning models. As described in more detail below, in one aspect of this disclosure, input data associated with a new concept to be learned by a trained machine learning model can be obtained. Initial weights of the trained machine learning model and one or more previous weight deltas associated with the trained machine learning model can be identified. The one or more previous weight deltas can represent one or more weight deltas related to one or more concepts previously learned by the trained machine learning model after the initial weights of the trained machine learning model have been established. One or more additional weight deltas can be identified based on the input data, and the identification of the one or more additional weight deltas can be guided by the initial weights and the one or more previous weight deltas. The one or more additional weight deltas are integrated into the trained machine learning model, such as by identifying updated weights for the trained machine learning model based on the initial weights, the one or more previous weight deltas, and the one or more additional weight deltas.

In another aspect of this disclosure, input data associated with a user request for the trained machine learning model may be obtained. For example, the input data may include text associated with a user request to generate an image. One or more customized tokens associated with the input data can be identified, and the one or more customized tokens can be associated with one or more of multiple previous concepts learned by the trained machine learning model. For instance, the one or more customized tokens may relate to one or more people, settings, or other content to be included in the image to be generated. Key, value, and query features can be identified based on the input data and the one or more customized tokens, and key-value projection can be performed using the key features, the value features, and weights of the trained machine learning model to generate projected features. A response to the user request can be generated based on the query features and the projected features, such as when an image is generated based on the query features and the projected features. The weights of the trained machine learning model can be modified by sequentially teaching the trained machine learning model one or more new concepts over time, such as by using the techniques noted above.

In this way, the disclosed techniques support the customization of text-to-image generation machine learning models or other machine learning models by allowing the models to learn multiple fine-grained concepts in a sequential manner. Among other things, this can provide more efficient user engagement with the text-to-image generation machine learning models or other machine learning models. Moreover, the described techniques allow the text-to-image generation machine learning models or other machine learning models to learn additional concepts while reducing or eliminating problems associated with catastrophic forgetting. In addition, the text-to-image generation machine learning models or other machine learning models can learn new concepts via the introduction of only a marginal number of additional parameters and may require no long-term storage of user data, which can increase user privacy and security.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices) for customization and use, this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may be used to perform various operations related to sequential customization of one or more text-to-image diffusion models or other machine learning models, such as a learning process that teaches new concepts to the machine learning model(s) or an inferencing process that relies on one or more concepts learned by the machine learning model(s).

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications for sequential customization of one or more text-to-image diffusion models or other machine learning models. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may be used to perform various operations related to sequential customization of one or more text-to-image diffusion models or other machine learning models, such as a learning process that teaches new concepts to the machine learning model(s) or an inferencing process that relies on one or more concepts learned by the machine learning model(s).

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

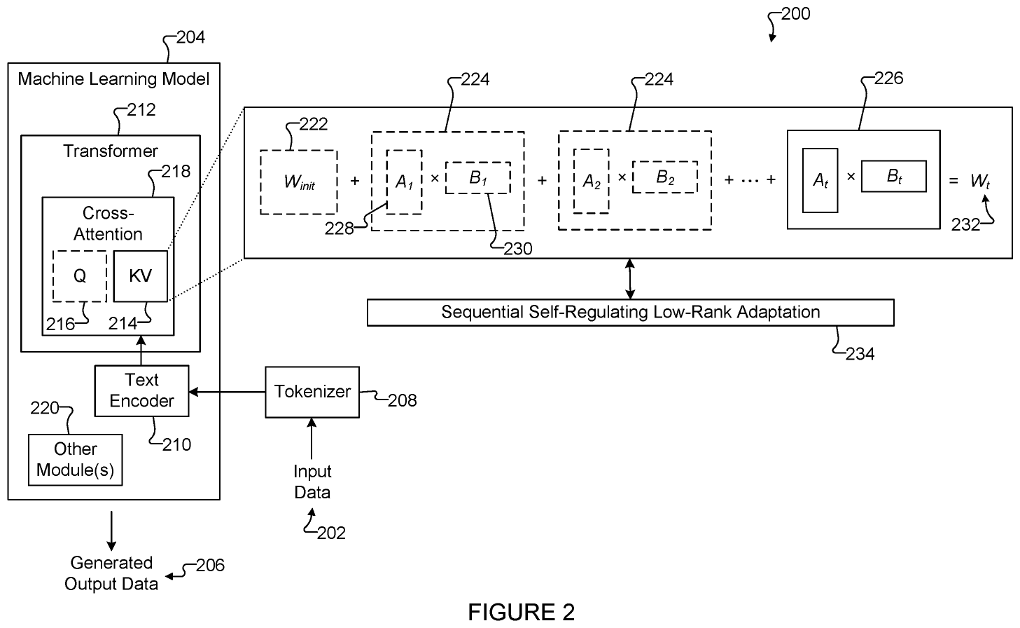

FIG. 2 illustrates an example architecture 200 for sequential customization of a text-to-image diffusion model or other machine learning model in accordance with this disclosure. For case of explanation, the architecture 200 shown in FIG. 2 is described as being implemented on or supported by the electronic device 101 in the network configuration 100 of FIG. 1. However, the architecture 200 shown in FIG. 2 could be used with any other suitable device(s) and in any other suitable system(s), such as when the architecture 200 is implemented on or supported by the server 106.

As shown in FIG. 2, the architecture 200 generally operates to receive and process input data 202, which can include or be based on input prompts associated with at least one user's requests. The input data 202 can vary depending on the functionality of the architecture 200 and depending on whether the architecture 200 is learning new concepts or is being used during inferencing based on currently-known concepts. When the architecture 200 is learning a new concept, the input data 202 may include images or other data associated with the new concept, as well as a user description or other text about the new concept. When the architecture 200 is performing inferencing, the input data 202 may include an identification of one or more already-learned concepts, as well as a user description or other text describing the function to be performed by the architecture 200. For example, in some embodiments, the architecture 200 is configured to perform text-to-image generation, and the input data 202 can include an input prompt requesting that the architecture 200 learn a new concept based on one or more images of the new concept or requesting that the architecture 200 generate one or more new images based on one or more already-learned concepts. As particular examples, certain input data 202 including images may be used to teach the architecture 200 who certain people are and what certain settings (environments) are, and subsequent input data 202 may include an input prompt requesting that the architecture 200 generate an image containing one or more of the people in a specified setting.

The input data 202 is provided to a machine learning model 204, which can process the input data 202 to either learn new concepts or generate output data 206 resulting from inferencing. Again, the output data 206 can vary depending on the functionality of the architecture 200. For example, in some embodiments, the architecture 200 is configured to perform text-to-image generation, and the output data 206 can include at least one image generated by the machine learning model 204, where the at least one image contains contents specified in an input prompt. Note that while the machine learning model 204 is often described as receiving requests and generating images based on the requests, this is for illustration and explanation only. The machine learning model 204 may be trained to perform any of a wide variety of functions, and this disclosure is not limited to use with only text-to-image generation.

In some embodiments, the input data 202 is pre-processed using a tokenizer 208, which generally operates to convert text contained in the input data 202 into tokens. Each token represents a portion of the text, such as a word, a portion of a word, or punctuation contained in the text. The tokenizer 208 can also generate tokenized text vectors, which represent vectors containing or based on the tokens identified by the tokenizer 208. In addition, as described below, the tokenizer 208 can identify one or more customized tokens, where each customized token may be associated with a concept previously learned by the machine learning model 204 or to be learned by the machine learning model 204. For instance, in some embodiments where the machine learning model 204 is configured to perform text-to-image generation, different customized tokens may be associated with different people, objects, settings, or other contents that might be included in generated images. In some cases, the tokenizer 208 can insert one or more customized tokens associated with an input prompt into the tokenized text vector associated with the input prompt. Thus, the customized tokens can be learned during the learning process and used by the tokenizer 208 during the inferencing process.

The tokenized data from the tokenizer 208 is provided to a text encoder 210 of the machine learning model 204. The text encoder 210 generally operates to convert the tokenized data from the tokenizer 208 into vector embeddings within a learned feature space of the machine learning model 204. For example, the text encoder 210 may generate vector embeddings associated with the words, any customized token(s), and other contents of the tokenized data, as well as positional embeddings related to the relative positions of the words, customized token(s), and other contents of the tokenized data.

The vector embeddings from the text encoder 210 are provided to a transformer 212 of the machine learning model 204, which processes the vector embeddings. As part of this processing, the transformer 212 can identify and provide key (K) and value (V) features 214 and query (Q) features 216 to at least one cross-attention layer 218. The key and value features 214 may represent data from the text encoder 210, and the query features 216 may represent data generated by the transformer 212. The at least one cross-attention layer 218 can perform cross-attention using the key and value features 214 and the query features 216. Thus, for instance, the key and value features 214 can represent at least one concept associated with an input prompt, the query features 216 can be compared to the key features to measure the similarity or relevance of different queries to the at least one concept, and the value features can be used based on the measured level of similarity or relevance.

Data generated by the at least one cross-attention layer 218 can be used by one or more other modules 220 of the machine learning model 204 in order to generate the output data 206 during inferencing. For example, the one or more other modules 220 may include a variational autoencoder (VAE) that can process the data generated by the at least one cross-attention layer 218 in order to generate one or more images or other output data 206. Note that the specific implementation of the one or more other modules 220 can vary based on the design of the machine learning model 204.

As part of the processing by the transformer 212, the at least one cross-attention layer 218 can perform a key-value projection, which represents a mathematical projection of the key and value features 214 based on weights associated with the machine learning model 204. The weights of the machine learning model 204 here are decomposed into initial weights 222, one or more previous weight deltas 224, and one or more additional weight deltas 226. The initial weights 222 represent weights identified during initial training of the machine learning model 204. For example, the initial weights 222 can be established during training when one or more training datasets are provided to the machine learning model 204 and outputs from the machine learning model 204 are compared to desired outputs (called ground truths). When the generated and desired outputs differ, this can be used to calculate a loss associated with the machine learning model 204. The weights used by the machine learning model 204 can be adjusted during this training to reduce or minimize the calculated loss for the machine learning model 204. The initial weights 222 therefore represent the weights that result in a minimized or other acceptable loss for the machine learning model 204 during training based on the training dataset(s) used during the training.

Each previous weight delta 224 is associated with a concept that the machine learning model 204 previously learned after the training in which the initial weights 222 were established. As a particular example, each previous weight delta 224 may be associated with a different person, setting, or other contents that might be used by the machine learning model 204 to generate images. Each additional weight delta 226 is associated with a new concept that the machine learning model 204 is currently learning, meaning this occurs after the concept(s) associated with the previous weight delta(s) 224 have been learned. Again, as a particular example, each additional weight delta 226 may be associated with a different person, setting, or other contents that might be used by the machine learning model 204 to generate images. In this example, each weight delta 224 and 226 is associated with two low-rank matrices 228 and 230. Updated weights 232 being used by the machine learning model 204 can be determined by multiplying the matrices 228 and 230 of each weight delta 224, 226 and summing the results with the initial weights 222.

In some embodiments, when the machine learning model 204 is initially trained and deployed, it may include the initial weights 222 without any weight deltas 224, 226. To help the machine learning model 204 learn a first new concept, the machine learning model 204 may receive first input data 202 related to the first new concept, and gradient descent optimization or other techniques may be used to identify the low-rank matrices 228 and 230 for a first new additional weight delta 226 based on the first input data 202. To help the machine learning model 204 learn a second new concept, the machine learning model 204 may receive second input data 202 related to the second concept, and gradient descent optimization or other techniques may be used to identify the low-rank matrices 228 and 230 for a second new additional weight delta 226 based on the second input data 202. Note that the first new additional weight delta 226 may be treated as a first previous weight delta 224 during the identification of the second new additional weight delta 226. This process may occur sequentially over time, where each new additional weight delta 226 is identified based on the initial weights 222 and any previous weight deltas 224. When an input prompt is received requesting generation of an image or other output data 206, the initial weights 222 and weight deltas 224, 226 can be combined to produce the updated weights 232, and the updated weights 232 can be used by the machine learning model 204 to generate the requested output data 206.

In this example, the weight deltas 224, 226 can be identified using a sequential self-regulating low-rank adaptation function 234, which can be used to identify an additional weight delta 226 for each new concept being learned based on the initial weights 222 and any previous weight deltas 224. The function 234 is described as sequential since the additional weight deltas 226 can be added sequentially over time and possibly over a long period of time. The function 234 is described as self-regulating because the function 234 can use a forgetting regularization loss function when determining each additional weight delta 226, where the forgetting regularization loss function can help to avoid learning new concepts in a manner that causes significant forgetting of previously-learned concepts associated with the initial weights 222 and any previous weight deltas 224. The function 234 is described as low-rank since each of the additional weight deltas 226 can be defined using low-rank matrices 228 and 230, which can facilitate easier storage and use of the weight deltas 224, 226. Note that the forgetting regularization loss function can be used only when the machine learning model 204 is learning new concepts and need not be used during inference operations.

One purpose of the sequential self-regulating low-rank adaptation function 234 can be to update a small number of weights for the machine learning model 204 in a way that does not overfit the machine learning model 204 to each new concept and providing the ability to learn future concepts, while at the same time not overwrite information learned from past concepts to avoid catastrophic forgetting. Note that the use of a single weight delta 224 or 226 may be inadequate in some circumstances since the machine learning model 204 can be trained to produce images or other output data 206 based on multiple learned concepts at the same time. As a particular example, a user may want the machine learning model 204 to produce an image with a specific family member sitting with the user's new pet in a novel setting. Thus, the machine learning model 204 may need to use multiple learned concepts after initial training in order to generate such an image.

The sequential self-regulating low-rank adaptation function 234 accomplishes this by fine-tuning a small number of weights using sequential self-regularized low-rank adaptors (the weight deltas 224, 226). The use of the weight deltas 224, 226 supports parameter efficiency by allowing past task parameters to be stored for regularization of future tasks. The use of the weight deltas 224, 226 also supports inference efficiency since learned parameters of the weight deltas 224, 226 can be easily combined with the initial weights 222 to identify the updated weights 232. Moreover, the use of the weight deltas 224, 226 provides the ability to self-regularize in order to reduce or avoid catastrophic forgetting issues. This can be accomplished by guiding the generation of each additional weight delta 226 based on the initial weights 222 and any previous weight deltas 224. The result is that each additional weight delta 226 is associated with parameters that are less likely to interfere with the initial weights 222 and any previous weight deltas 224.

In addition, customized tokens may be used to represent various concepts learned by the machine learning model 204, where embeddings of the customized tokens are relatively far from each other in an embedding space. In some cases, the customized tokens can be randomly initialized, and the customized tokens may be used by the machine learning model 204 (rather than names of specific people, objects, settings, etc. contained in an input prompt). This encourages the customized tokens to give unique or more customized instructions to the cross-attention layer(s) 218 of the machine learning model 204, rather than having overlapping instructions that can interfere with past and future concepts.

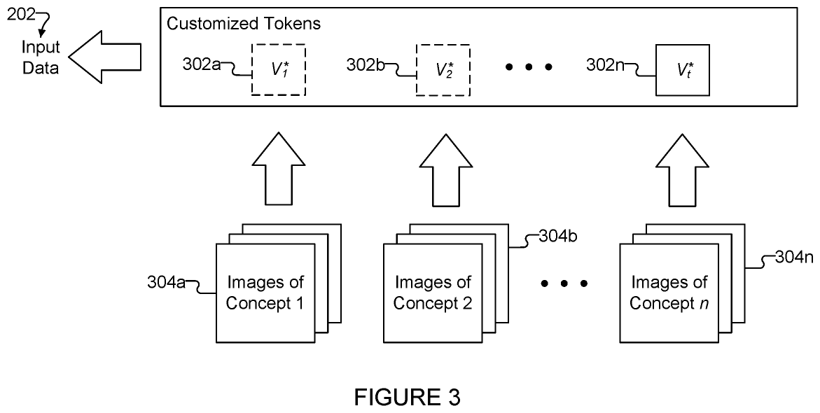

FIG. 3 illustrates an example use of customized tokens during sequential customization of a text-to-image diffusion model or other machine learning model 204 in accordance with this disclosure. For case of explanation, the customized tokens shown in FIG. 3 are described as being used by the electronic device 101 in the network configuration 100 of FIG. 1. However, the customized tokens shown in FIG. 3 could be used with any other suitable device(s) and in any other suitable system(s), such as when the customized tokens are used by the server 106.

As shown in FIG. 3, a customized token 302a-302n is associated with each concept learned by the machine learning model 204 after initial training. In this example, each customized token 302a-302n may be associated with a collection of one or more images 304a-304n, where each collection is associated with a different concept. For example, when the machine learning model 204 represents a text-to-image generation model, each collection may include images of a different person, object, or setting. Thus, there can be N personalized tokens 302a-302n (denoted as V*₁, V*₂, . . . , V*_{N}) that are available for use.

When an input prompt included in input data 202 from a user includes one or more specific concepts that the machine learning model 204 has already learned, the one or more specific concepts in the input prompt can be replaced using one or more associated customized tokens. Thus, for instance, a request to generate an image containing two or more people in a particular setting may cause the tokenizer 208 to replace the names of the two or more people and the name of the setting with their associated customized tokens.

In some cases, the customized tokens 302a-302n can be learned via direct optimization, which can be thought of as providing instructions included in the associated input data 202. Instead of initializing the customized tokens 302a-302n using lesser-used words, the customized tokens 302a-302n can be initialized with random embeddings in the token embedding space. In combination with removing specific names of learned concepts from the input data 202 to encourage the use of unique personalized embeddings, this allows the machine learning model 204 to produce images or other outputs of multiple learned concepts at the same time during inferencing.

Among other things, the custom tokenization approach improves the ability of the machine learning model 204 to learn multiple concepts without interference. When including specific names (such as the name of a specific person) or when using names for token initialization, interference tends to be much higher. For example, many concepts may be completely overwritten based on future task data. When initializing with random lesser-used tokens, some initializations may be better than others, leading the better tokens to incur less forgetting than the poorer tokens. However, using the customized tokens in combination with sequential self-regulating low-rank adaptation can help to overcome this issue.

A specific implementation of the sequential self-regulating low-rank adaptation function 234 may operate in the following manner. Note that the details of this specific implementation are examples only and that the sequential self-regulating low-rank adaptation function 234 may be implemented in any other suitable manner.

Assume the machine learning model 204 is being sequentially taught customized tasks t∈{1, 2, . . . , N-1, N}, where N is the total number of new concepts that the machine learning model 204 will learn. For a single-head cross-attention operation, the cross-attention operation can be expressed as follows.

$${ℱ}_{attn} ( Q , K , V ) = σ ( \frac{{QK}^{T}}{\sqrt{{d}^{′}}} ) V$$

Here, σ represents a soft-max operator, Q=W^{Q}f represents the query features, K=W^{K}c represents the key features, V=W^{V}c represents the value features, f represents latent image features, c represents text features, and d′ represents an output dimension. The matrices W^{Q}, W^{K}, and W^{V} map the inputs f and c to the query, key, and value features, respectfully. Based on this, when training the machine learning model 204 to learn a new concept, only the matrices W^{K} and W^{V} may be modified, where the matrices W^{K} and W^{V} project the text features of an input prompt. These matrices W^{K} and W^{V} are referred to collectively as W^{K,V} below.

When the machine learning model 204 is learning a new concept, the sequential self-regulating low-rank adaptation function 234 can attempt to minimize the following loss function.

$${min}_{{W}_{t}^{K , V} ∈ θ} {ℒ}_{SD} ( x , θ ) + {λ}_{f} {ℒ}_{forget} ( {W}_{t - 1}^{K , V} , {W}_{t}^{K , V} )$$

Here, x represents the input data 202 for the new concept, and [symbol] ₛₚ represents a stable diffusion loss function for the machine learning model 204 (assuming the machine learning model 204 implements stable diffusion). Also, Wₜ₋₁^{K,V} represents at least one old task associated with one or more concepts previously learned by the trained machine learning model, and Wₜ^{K,V} represents a new task associated with the new concept. Further, [symbol] _{forget} represents a forgetting regularization loss function and is used to help reduce or minimize forgetting between Wₜ₋₁^{K,V} and Wₜ^{K,V}. In addition, λ_{f} represents a tunable hyperparameter, which in some cases may have a simple exponential sweep.

The weight delta between a previous task Wₜ₋₁^{K,V} and a new task Wₜ^{K,V} can be parameterized using low-rank adaptation parameters, which decomposes weight matrices into low-rank residuals. In some cases, this can be expressed as follows.

$${W}_{t}^{K , V} = {W}_{t - 1}^{K , V} + {A}_{t}^{K , V} {B}_{t}^{K , V} = {W}_{init}^{K , V} + [ {\sum }_{{t}^{′} = 1}^{t - 1} {A}_{{t}^{′}}^{K , V} {B}_{{t}^{′}}^{K , V} ] + {A}_{t}^{K , V} {B}_{t}^{K , V}$$

Here, Wᵢₙᵢₜ^{K,V} represents the initial weights 222 of the machine learning model 204 used for the key-value projection. Also, Aₜ^{K,V}∈ [symbol] ^{D}^{₁}^{×r} and Bₜ^{K,V}∈ [symbol] ^{r×D}^{₂} represent the matrices 228 and 230 for the new concept, where W^{K,VE}∈ [symbol] ^{D}^{₁}^{×D}^{₂}. In addition, r represents a hyperparameter controlling the rank of the weight matrix update, which in some cases may be selected using a simple grid search.

To reduce or avoid issues related to catastrophic forgetting, the sequential self-regulating low-rank adaptation function 234 can implement a regularization that works well without storing old input data 202 used to learn prior concepts. This regularization can be achieved by penalizing each additional weight delta 226 (represented as Aₜ^{K,V} and Bₜ^{K,V}) for altering weights of the machine learning model 204 that have been edited by previous concepts in the corresponding Wₜ^{K,V}. In other words, the regularization forces each additional weight delta 226 to try and use portions of a feature space not substantially used by the previous weight deltas 224 (represented as Aₜ^{K,V} and Bₜ^{K,V}). In some cases, the summed products of the previous weight deltas 224 themselves may be used to penalize future changes. A specific example of this regularization may be expressed as follows.

$${ℒ}_{forget} = {‖ \vert {\sum }_{{t}^{′} = 1}^{t - 1} {A}_{{t}^{′}}^{K , V} {B}_{{t}^{′}}^{K , V} \vert ⊙ {A}_{t}^{K , V} {B}_{t}^{K , V} ‖}_{F}^{2}$$

Here, Aₜ^{K,V} and Bₜ^{K,V} represent one or more previous weight deltas 224 associated with one or more concepts previously learned by the machine learning model 204, and Aₜ^{K,V} and Bₜ^{K,V} represent an additional weight delta 226 associated with a new concept. Also, ⊙ represents an element-wise product (which is also known as the Hadamard product), |·| represents an element-wise absolute value, and ∥·∥_{F} represents the Frobenius norm. This penalty self-regularizes future weight deltas with high effectiveness and efficiency. Note that the A and B matrices are low-rank matrices and thus only incur small costs for learning and storage.

In some cases, the low-rank properties of A and B may not be able to target the initial weight matrix (the initial weights 222) with precision. For example, when learning a larger number of new concepts, the chances of overwriting the same spot within the feature spaces increases. In some embodiments, this can be handled by targeting weight updates with more precision, which can be achieved using a hard-attention mask. The hard-attention mask can be based on a learnable mask tensor that contains learnable mask parameters, and the learnable mask parameters can be parameterized using a categorical distribution. In particular embodiments, the learnable mask parameters can be parameterized using a binary categorical distribution with the Gumbel-Softmax operation. The hard-attention mask is applied during updating of the weights of the machine learning model 204.

As a particular example of this, the hard-attention mask may be expressed as follows.

$${ℳ}_{t , i , j}^{K , V} = \frac{exp ( \frac{log ( {\hat{m}}_{t , i , j , 1}^{K , V} ) + {g}_{i , j , 1}}{τ} )}{{\sum }_{z = 0}^{1} exp ( \frac{log ( {\hat{m}}_{t , i , j , z}^{K , V} ) + {g}_{i , j , z}}{τ} )}$$

Here, \hat{m}ₜ^{K,V} ∈ [symbol] ^{D}^{₁}^{×D}^{₂}^{×2} represents the learnable mask tensor before the Gumbel-Softmax is taken over the expanded third dimension, and i and j indicate that the Gumbel-Softmax is taken over i=1, . . . , D₁ and j=1, . . . , D₂. Also, τ represents a temperature hyperparameter that controls smoothness of the results. In addition, g represents independent and identically distributed samples taken from a Gumbel (0, 1) distribution. The notation [symbol] ₜ^{K,V} is used below to represent the final learned hard-attention mask, which can be applied to the product of Aₜ^{K,V} and Bₜ^{K,V}. Based on this, the weight delta between a previous task Wₜ₋^{K,V} and a new task Wₜ^{K,V} can be parameterized as follows.

$${W}_{t}^{K , V} = {W}_{t - 1}^{K , V} + {A}_{t}^{K , V} {B}_{t}^{K , V} ⊙ {ℳ}_{t}^{K , V} = {W}_{init}^{K , V} + [ {\sum }_{{t}^{′} = 1}^{t - 1} {A}_{{t}^{′}}^{K , V} {B}_{{t}^{′}}^{K , V} ⊙ {ℳ}_{{t}^{′}}^{K , V} ] + {A}_{t}^{K , V} {B}_{t}^{K , V} ⊙ {ℳ}_{t}^{K , V}$$

The forgetting regularization loss function can also be updated as follows.

$${ℒ}_{forget} = {‖ \vert {\sum }_{{t}^{′} = 1}^{t - 1} {A}_{{t}^{′}}^{K , V} {B}_{{t}^{′}}^{K , V} ⊙ {ℳ}_{{t}^{′}}^{K , V} \vert ⊙ ( {A}_{t}^{K , V} {B}_{t}^{K , V} ⊙ {ℳ}_{t}^{K , V} ) ‖}_{F}^{2}$$

Note that the hard-attention mask may not be input data-conditioned during a forward pass of the machine learning model 204.

While this represents one technique for generating a hard-attention mask, other suitable techniques may be used. For example, rather than optimize a fixed tensor, it is possible to further enhance the hard-attention mask (and the customized token capacity described above) with a low-rank multi-layer perception (MLP) parameterization operating on a fixed input. This leverages the power of MLPs to learn more complex transformations, thereby further mitigating the risk of catastrophic forgetting. In some cases, this can be accomplished using a two-layer MLP that includes two linear layers and a rectified linear unit (ReLU) activation operating on a fixed input tensor, which helps keep the number of learnable parameters low. For customized tokens, a custom token feature embedding V*ₜ can be replaced with a learnable MLP module θ_{V*}_{ₜ} Based on this, the hard-attention mask may be expressed as follows.

$${θ}_{{ℳ}_{t , i , j}^{K , V}} = \frac{exp ( \frac{log ( {θ}_{{\hat{m}}_{t , i , j , 1}^{K , V}} ) + {g}_{i , j , 1}}{τ} )}{{\sum }_{z = 0}^{1} exp ( \frac{log ( {θ}_{{\hat{m}}_{t , i , j , z}^{K , V}} ) + {g}_{i , j , z}}{τ} )}$$

Here,θ_{\hat{m}}_{_{t,i,j,1}}_{^{K,V}} now represents a learnable mask tensor before the Gumbel-Softmax is taken. The forgetting regularization loss function can also be updated as follows.

$${ℒ}_{forget} = {‖ \vert {\sum }_{{t}^{′} = 1}^{t - 1} {A}_{{t}^{′}}^{K , V} {B}_{{t}^{′}}^{K , V} ⊙ {θ}_{{ℳ}_{{t}^{′}}^{K , V}} \vert ⊙ ( {A}_{t}^{K , V} {B}_{t}^{K , V} ⊙ {θ}_{{ℳ}_{t}^{K , V}} ) ‖}_{F}^{2}$$

In addition, it may be desirable to perform sparsity regularization in order to reduce the number of non-zero values contained in a hard-attention mask. This allows sparsity regularization to be used to achieve desired sparsity properties of the hard-attention mask. For example, the sparsity regularization can encourage the hard-attention mask to produce a zero value at each location in the weight matrix residual rather than a one value. As a result, outputs of the low-rank matrix updates (which are less important to learning a new task) are zeroed out, leading to precise and minimal changes to the pretrained weights. Moreover, since the hard-attention mask is truly binary, the hard-attention mask does not allow for learning of complex high-rank features, which could potentially interfere with the robust low-rank fine-tuning properties of the approaches described above. Instead, the hard-attention mask provides the machine learning model 204 with a clear delineation of which parameters are deemed important for the task at hand. In some cases, this can be accomplished by introducing sparsity regularization on positive outputs of the hard-attention mask, which may be expressed as follows.

$${ℒ}_{sparse} = {‖ {θ}_{{ℳ}_{t}^{K , V}} ( 1 ) ‖}_{1}$$

Based on that, the sequential self-regulating low-rank adaptation function 234 can now attempt to minimize the following loss function.

$${min}_{( {W}_{t}^{K , V} ∈ θ , {θ}_{{V}_{t}^{*}} )} {ℒ}_{SD} ( x , θ ) + {λ}_{s} {ℒ}_{sparse} ( {θ}_{{ℳ}_{t}^{K , V}} ( 1 ) ) + {λ}_{f} {ℒ}_{forget} ( {W}_{t - 1}^{K , V} , {W}_{t}^{K , V} )$$

Here, As represents a tunable hyperparameter.

Note that certain components in FIGS. 2 and 3 are shown in dashed lines, such as the query features 216, initial weights 222, previous weight deltas 224, and earlier customized tokens 302a-302b. When the machine learning model 204 is learning a new concept, the architecture 200 can be used to generate an additional weight delta 226 and an additional customized token 302n for the new concept. During this learning process, the components in FIGS. 2 and 3 shown in dashed lines can be frozen or remain unchanged. As a result, generating the additional weight delta 226 for the new concept may not result in any modifications to the previous weight deltas 224 associated with previously-learned concepts, and generating the additional customized token 302n for the new concept may not result in any modifications to the customized tokens 302a-302b associated with previously-learned concepts. During inferencing, all of the initial weights 222, weight deltas 224, 226, and customized tokens 302a-302n can be frozen and used to generate desired output data 206 requested by input prompts.

The machine learning model 204 may have any suitable machine learning architecture and be implemented in any suitable manner. In some embodiments, for example, the machine learning model 204 as a whole may be implemented using a diffusion machine learning model architecture. Also, the transformer 212 may be implemented using a convolution neural network (such as U-net) or other neural network.

Although FIG. 2 illustrates one example of an architecture 200 for sequential customization of a text-to-image diffusion model or other machine learning model 204, various changes may be made to FIG. 2. For example, various components and functions in FIG. 2 may be combined, further subdivided, replicated, rearranged, or omitted according to particular needs. Also, one or more additional components and functions may be included in FIG. 2 if needed or desired. Although FIG. 3 illustrates one example use of customized tokens 302a-302n during sequential customization of a text-to-image diffusion model or other machine learning model 204, various changes may be made to FIG. 3. For instance, it is possible to use sequential self-regulating low-rank adaptation without using customized tokens.

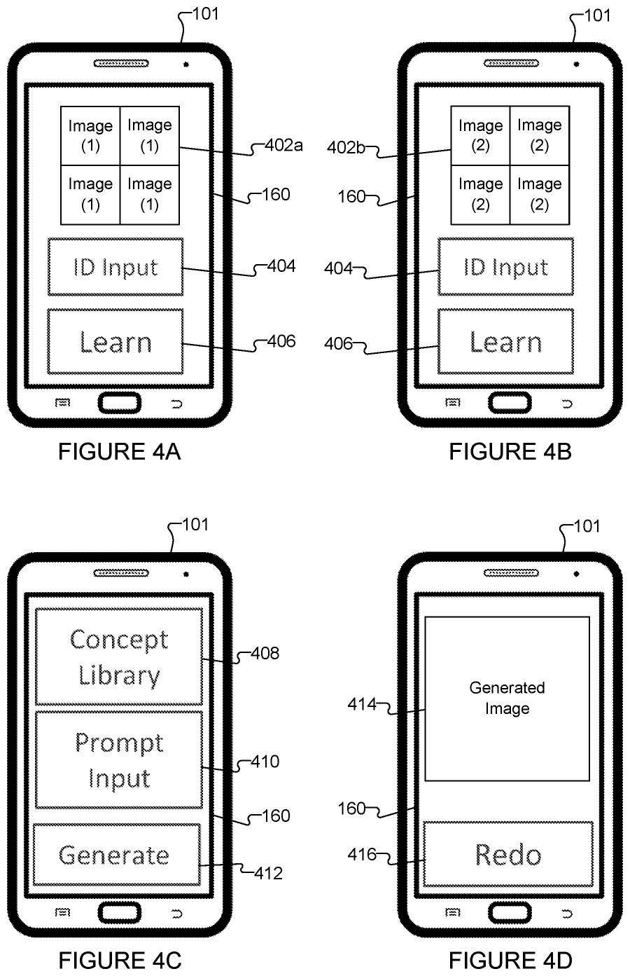

FIGS. 4A through 4D illustrate an example use case for sequential customization of a text-to-image diffusion model or other machine learning model 204 in accordance with this disclosure. For case of explanation, the use case shown in FIGS. 4A through 4D is described as involving the use of the electronic device 101 in the network configuration 100 of FIG. 1. However, the use case shown in FIGS. 4A through 4D could be performed using any other suitable device(s) and in any other suitable system(s), such as when the use case involves the use of the server 106. In FIGS. 4A through 4D, it is assumed that the electronic device 101 includes or has access to a trained machine learning model 204, such as when the trained machine learning model 204 (including its initial weights 222) is stored on the memory 130 of the electronic device 101.

As shown in FIG. 4A, the electronic device 101 has obtained one or more images 402a of a first new concept. The one or more images 402a may be obtained in any suitable manner, such as when a user of the electronic device 101 downloads the image(s) 402a from the Internet or other source(s) or uses the electronic device 101 to capture the image(s) 402a. The electronic device 101 also displays an identification (ID) button 404 and a learn button 406 on the display 160. The user may select the ID button 404 in order to provide a name or other text of the first new concept associated with the image(s) 402a. The user may select the learn button 406 to cause the electronic device 101 to learn the first new concept based on the image(s) 402a and the name or other text of the first new concept provided by the user. Among other things, selection of the learn button 406 can cause the electronic device 101 to generate a customized token 302a for the first new concept and generate an additional weight delta 226 for the first new concept, both of which can be stored (such as in the memory 130 of the electronic device 101).

As shown in FIG. 4B, the electronic device 101 has obtained one or more images 402b of a second new concept. Again, the one or more images 402b may be obtained in any suitable manner, such as when a user of the electronic device 101 downloads the image(s) 402b from the Internet or other source(s) or uses the electronic device 101 to capture the image(s) 402b. The electronic device 101 also displays the ID button 404 and the learn button 406 on the display 160. The user may select the ID button 404 in order to provide a name or other text of the second new concept associated with the image(s) 402b. The user may select the learn button 406 to cause the electronic device 101 to learn the second new concept based on the image(s) 402b and the name or other text of the second new concept provided by the user. Among other things, selection of the learn button 406 can cause the electronic device 101 to generate another customized token 302b for the second new concept and generate another additional weight delta 226 for the second new concept, both of which can be stored (such as in the memory 130 of the electronic device 101). The additional weight delta 226 for the first new concept is treated as a previous weight delta 224 during generation of the additional weight delta 226 for the second new concept.

This process can be repeated once or any number of times sequentially. The images and the text that are used by the machine learning model 204 may relate to any suitable concepts being learned by the machine learning model 204, such as people, objects, and settings. Note that during the learning process shown in FIGS. 4A and 4B, the images 404a-404b and the text provided by the user may be used to learn the new concepts and then deleted from the electronic device 101. This is because the electronic device 101 does not need to retain this information once the new customized tokens and weight deltas have been identified, which can improve user privacy and security.

As shown in FIG. 4C, the electronic device 101 can also present a display that contains a concept library button 408, a prompt input button 410, and a generate button 412. Selection of the concept library button 408 can cause the electronic device 101 to present a list or other collection of the concepts that the user has taught the machine learning model 204. For example, the electronic device 101 may present a list or other collection of the people, objects, and settings that the machine learning model 204 has learned based on data from the user. The user may select one or more of those concepts for use in generating a new image, which allows the electronic device 101 to identify the customized token(s) associated with the one or more selected concepts.

Selection of the prompt input button 410 allows the user to provide text describing the new image, such as when the user is able to provide text indicating that the user wants to generate an image of one or more people and/or one or more objects in a specified setting. Selection of the generate button 412 causes the electronic device 101 to use the machine learning model 204 to generate the new image, which can be presented to the user as an image 414 as shown in FIG. 4D. The image 414 may be used in any suitable manner, such as when the image 414 is shared via email, text message, or social media post or when the image 414 is downloaded to a camera roll of the electronic device 101. A redo button 416 can cause the electronic device 101 to generate another new image or to return to the state shown in FIG. 4C so that the user can modify the selected concept(s) or the input prompt.

Although FIGS. 4A through 4D illustrate one example of a use case for sequential customization of a text-to-image diffusion model or other machine learning model, various changes may be made to FIGS. 4A through 4D. For example, while the use of specific buttons and other input/output mechanisms is shown and described here, the electronic device 101 may use any other suitable interfaces and input/output mechanisms to receive and provide information. Also, this represents one example way in which the trained machine learning model 204 may be used with new concepts. However, the trained machine learning model 204 may be used in any other suitable manner. For instance, these techniques may be used on a wide range of devices, including mobile smartphones, desktop/laptop/tablet computers, and extended reality headsets. Extended reality is a term that generally refers to virtual reality, augmented reality, and mixed reality devices. Moreover, these techniques may be used in a wide variety of use cases. As examples, in addition to text-to-image generation, these techniques may be used with vision-based personal assistants and image event classifiers, such as when these techniques are applied to images (like in a user's camera roll) in order to classify the people, objects, or settings contained in the images.

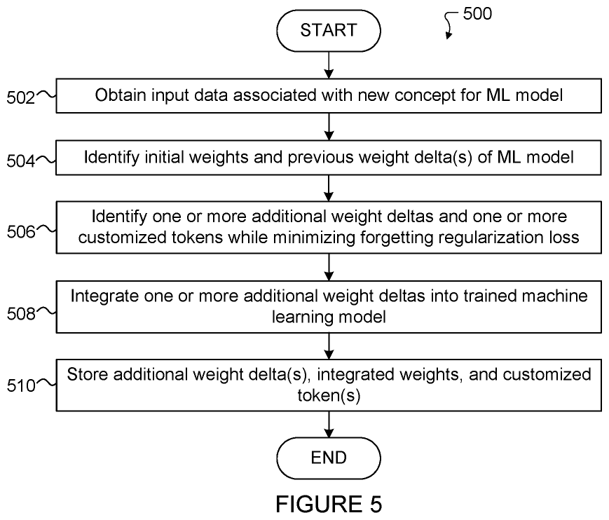

FIG. 5 illustrates an example method 500 for training a text-to-image diffusion model or other machine learning model 204 during sequential customization in accordance with this disclosure. For ease of explanation, the method 500 shown in FIG. 5 is described as being performing using the electronic device 101 in the network configuration 100 of FIG. 1. However, the method 500 shown in FIG. 5 could be performed using any other suitable device(s) and in any other suitable system(s), such as when the method 500 is performed using the server 106.

As shown in FIG. 5, input data associated with a new concept to be learned by a trained machine learning (ML) model is obtained at step 502. This may include, for example, the processor 120 of the electronic device 101 obtaining one or more images and a name or other text associated with the new concept. Initial weights and any previous weight deltas associated with the trained machine learning model are identified at step 504. This may include, for example, the processor 120 of the electronic device 101 retrieving the initial weights 222 and any previous weight deltas 224 associated with the machine learning model 204, such as from the memory 130 of the electronic device 101.

One or more additional weight deltas and one or more customized tokens are identified while minimizing a forgetting regularization loss at step 506. This may include, for example, the processor 120 of the electronic device 101 randomly initializing a new customized token 302n for the new concept. This may also include the processor 120 of the electronic device 101 performing the sequential self-regulating low-rank adaptation function 234 to generate an additional weight delta 226 for the new concept. The additional weight delta 226 is guided by the initial weights 222 and any previous weight deltas 224, which means that the additional weight delta 226 is identified in a manner that allows the knowledge represented by the initial weights 222 and any previous weight deltas 224 to be substantially retained (thereby reducing or avoiding catastrophic forgetting issues). Note that any of the loss functions and forgetting regularization loss functions described above may be used here.

The one or more additional weight deltas are integrated into the trained machine learning model at step 508. This may include, for example, the processor 120 of the electronic device 101 combining the initial weights 222, any previous weight deltas 224, and the one or more additional weight deltas 226 to identify updated weights 232 for the machine learning model 204. This may optionally include the processor 120 of the electronic device 101 identifying a hard-attention mask based on a learnable mask tensor containing learnable mask parameters that are parameterized using a categorical distribution, where the updated weights 232 for the machine learning model 204 are identified based on the initial weights 222, any previous weight deltas 224, and the hard-attention mask applied to the one or more additional weight deltas 226. In some cases, the hard-attention mask may be identified by applying MLP parameterization to the learnable mask tensor to modify the learnable mask parameters prior to being parameterized using the categorical distribution. Also, in some cases, sparsity regularization may be performed to reduce the number of non-zero values contained in the hard-attention mask.

The one or more additional weight deltas, the integrated weights of the machine learning model, and the one or more new customized tokens are stored at step 510. This may include, for example, the processor 120 of the electronic device 101 storing the additional weight delta 224, the updated weights 232, and the new customized token 302n in the memory 130 of the electronic device 101. This allows the new concept to be used during subsequent inferencing operations. This also allows the new concept to be treated as a previously-learned concept if the user subsequently requests that the machine learning model 204 learn another new concept in the future.

Although FIG. 5 illustrates one example of a method 500 for training a text-to-image diffusion model or other machine learning model 204 during sequential customization, various changes may be made to FIG. 5. For example, while shown as a series of steps, various steps in FIG. 5 may overlap, occur in parallel, occur in a different order, or occur any number of times.

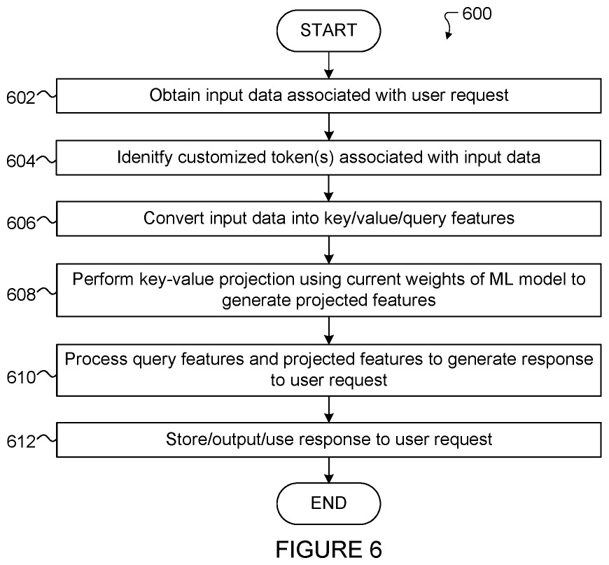

FIG. 6 illustrates an example method 600 for using a text-to-image diffusion model or other machine learning model 204 having learned during sequential customization in accordance with this disclosure. For case of explanation, the method 600 shown in FIG. 6 is described as being performing using the electronic device 101 in the network configuration 100 of FIG. 1. However, the method 600 shown in FIG. 6 could be performed using any other suitable device(s) and in any other suitable system(s), such as when the method 600 is performed using the server 106.

As shown in FIG. 6, input data associated with a user request is obtained at step 602. This may include, for example, the processor 120 of the electronic device 101 obtaining an identification of one or more previously-learned concepts and an input prompt containing text describing an image or other output to be generated from a user. One or more customized tokens associated with the input data are identified at step 604. This may include, for example, the processor 120 of the electronic device 101 retrieving one or more customized tokens 302a-302n based on the user's selection of one or more specific concepts or based on names or other text within the input prompt.

The input data is converted into key, value, and query features at step 606. This may include, for example, the processor 120 of the electronic device 101 using the tokenizer 208 to tokenize the text of the input prompt and to insert the one or more customized tokens 302a-302n into the resulting tokenized text vectors. This may also include the processor 120 of the electronic device 101 processing the tokenized text vectors to generate the key and value features 214. This may further include the processor 120 of the electronic device 101 using the transformer 212 to generate the query features 216. Key-value projection is performed using current weights of the machine learning model to generate projected features at step 608. This may include, for example, the processor 120 of the electronic device 101 using the updated weights 232 of the machine learning model 204 to perform the projection of the key and value features 214. As described above, the updated weights 232 of the machine learning model 204 can be based on the initial weights 222 and any weight deltas 224, 226 learned by the machine learning model 204 after the initial weights 222 of the machine learning model 204 were established during training.

The query features and the projected features are processed to generate a response to the user request at step 610. This may include, for example, the processor 120 of the electronic device 101 using a variational autoencoder or other module(s) 220 of the machine learning model 204 to generate suitable output data 206. As a particular example, the machine learning model 204 may generate an image containing one or more people and/or one or more objects in a specified setting as defined by the input prompt. The response to the user request is stored, output, or used in some manner at step 612. For example, the generated image or other output data 206 may be displayed on the display 160 of the electronic device 101, saved to a camera roll or otherwise stored in the memory 130 of the electronic device 101, or attached to or included within a text message, email, social media post, or other communication to be transmitted from the electronic device 101. Of course, the generated image or other output data 206 could be used in any other or additional manner.

Although FIG. 6 illustrates one example of a method 600 for using a text-to-image diffusion model or other machine learning model 204 having learned during sequential customization, various changes may be made to FIG. 6. For example, while shown as a series of steps, various steps in FIG. 6 may overlap, occur in parallel, occur in a different order, or occur any number of times.

It should be noted that the functions shown in or described with respect to FIGS. 2 through 6 can be implemented in an electronic device 101, server 106, or other device in any suitable manner. For example, in some embodiments, at least some of the functions shown in or described with respect to FIGS. 2 through 6 can be implemented or supported using one or more software applications or other software instructions that are executed by the processor 120 of the electronic device 101, server 106, or other device. In other embodiments, at least some of the functions shown in or described with respect to FIGS. 2 through 6 can be implemented or supported using dedicated hardware components. In general, the functions shown in or described with respect to FIGS. 2 through 6 can be performed using any suitable hardware or any suitable combination of hardware and software/firmware instructions. Also, the functions shown in or described with respect to FIGS. 2 through 6 can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, input data associated with a new concept to be learned by a trained machine learning model;
identifying, using the at least one processing device, initial weights of the trained machine learning model and one or more previous weight deltas associated with the trained machine learning model;
identifying, using the at least one processing device, one or more additional weight deltas based on the input data and guided by the initial weights and the one or more previous weight deltas; and
integrating, using the at least one processing device, the one or more additional weight deltas into the trained machine learning model;
wherein the one or more additional weight deltas are integrated into the trained machine learning model by identifying updated weights for the trained machine learning model based on the initial weights, the one or more previous weight deltas, and the one or more additional weight deltas.

2. The method of claim 1, wherein:
the trained machine learning model is configured to perform a key-value projection as part of at least one cross-attention function;
the at least one cross-attention function is configured to receive input from a text encoder of the trained machine learning model; and
the text encoder is configured to provide at least one embedding of at least one customized token associated at least one concept learned by the trained machine learning model.

3. The method of claim 1, wherein:
the one or more previous weight deltas are associated with one or more concepts previously learned by the trained machine learning model;
the one or more additional weight deltas are associated with the new concept; and
identifying the one or more additional weight deltas comprises performing sequential, self-regulating low-rank adaptation based on the one or more previous weight deltas.

4. The method of claim 1, wherein identifying the one or more additional weight deltas comprises minimizing a loss that is expressed as:
$${min}_{{W}_{t}^{K , V} ∈ θ} {ℒ}_{SD} ( x , θ ) + {λ}_{f} {ℒ}_{forget} ( {W}_{t - 1}^{K , V} , {W}_{t}^{K , V} )$$
where x represents the input data associated with the new concept, θ represents the trained machine learning model, [symbol] _{SD} represents a stable diffusion loss function, [symbol] _{forget} represents a forgetting regularization loss function, Wₜ₋₁^{K,V} represents at least one old task associated with one or more concepts previously learned by the trained machine learning model, Wₜ^{K,V} represents a new task associated with the new concept, and λ_{f} represents a tunable hyperparameter.

5. The method of claim 4, wherein the forgetting regularization loss function is expressed as:
$${ℒ}_{forget} = {‖ \vert {\sum }_{{t}^{′} = 1}^{t - 1} {A}_{{t}^{′}}^{K , V} {B}_{{t}^{′}}^{K , V} \vert ⊙ {A}_{t}^{K , V} {B}_{t}^{K , V} ‖}_{F}^{2}$$
where A_{t′}^{K,V} and B_{t′}^{K,V} represent the one or more previous weight deltas associated with the one or more concepts previously learned by the trained machine learning model, and Aₜ^{K,V} and Bₜ^{K,V} represent the one or more additional weight deltas associated with the new concept.

6. The method of claim 1, further comprising:
identifying, using the at least one processing device, a hard-attention mask based on a learnable mask tensor containing learnable mask parameters that are parameterized using a categorical distribution;
wherein the updated weights for the trained machine learning model are identified based on the initial weights, the one or more previous weight deltas, and the hard-attention mask applied to the one or more additional weight deltas.

7. The method of claim 6, wherein identifying the hard-attention mask comprises applying multi-layer perceptron (MLP) parameterization to the learnable mask tensor to modify the learnable mask parameters prior to being parameterized using the categorical distribution.

8. The method of claim 6, wherein identifying the hard-attention mask comprises performing sparsity regularization to reduce a number of non-zero values contained in the hard-attention mask.

9. An electronic device comprising:
at least one processing device configured to:
obtain input data associated with a new concept to be learned by a trained machine learning model;
identify initial weights of the trained machine learning model and one or more previous weight deltas associated with the trained machine learning model;
identify one or more additional weight deltas based on the input data and guided by the initial weights and the one or more previous weight deltas; and
integrate the one or more additional weight deltas into the trained machine learning model;
wherein, to integrate the one or more additional weight deltas into the trained machine learning model, the at least one processing device is configured to identify updated weights for the trained machine learning model based on the initial weights, the one or more previous weight deltas, and the one or more additional weight deltas.

10. The electronic device of claim 9, wherein:
the trained machine learning model is configured to perform a key-value projection as part of at least one cross-attention function;
the at least one cross-attention function is configured to receive input from a text encoder of the trained machine learning model; and
the text encoder is configured to provide at least one embedding of at least one customized token associated at least one concept learned by the trained machine learning model.

11. The electronic device of claim 9, wherein:
the one or more previous weight deltas are associated with one or more concepts previously learned by the trained machine learning model;
the one or more additional weight deltas are associated with the new concept; and
to identify the one or more additional weight deltas, the at least one processing device is configured to perform sequential, self-regulating low-rank adaptation based on the one or more previous weight deltas.

12. The electronic device of claim 9, wherein, to identify the one or more additional weight deltas, the at least one processing device is configured to minimize a loss that is expressed as:
$${min}_{{W}_{t}^{K , V} ∈ θ} {ℒ}_{SD} ( x , θ ) + {λ}_{f} {ℒ}_{forget} ( {W}_{t - 1}^{K , V} , {W}_{t}^{K , V} )$$
where x represents the input data associated with the new concept, θ represents the trained machine learning model, [symbol] ₛₚ represents a stable diffusion loss function, [symbol] _{forget} represents a forgetting regularization loss function, Wₜ₋₁^{K,V} represents at least one old task associated with one or more concepts previously learned by the trained machine learning model, Wₜ^{K,V} represents a new task associated with the new concept, and λ_{f} represents a tunable hyperparameter.

13. The electronic device of claim 12, wherein the forgetting regularization loss function is expressed as:
$${ℒ}_{forget} = {‖ \vert {\sum }_{{t}^{′} = 1}^{t - 1} {A}_{{t}^{′}}^{K , V} {B}_{{t}^{′}}^{K , V} \vert ⊙ {A}_{t}^{K , V} {B}_{t}^{K , V} ‖}_{F}^{2}$$
where Aₜ^{K,V} and Bₜ^{K,V} represent the one or more previous weight deltas associated with the one or more concepts previously learned by the trained machine learning model, and Aₜ^{K,V} and Bₜ^{K,V} represent the one or more additional weight deltas associated with the new concept.

14. The electronic device of claim 9, wherein:
the at least one processing device is further configured to identify a hard-attention mask based on a learnable mask tensor containing learnable mask parameters that are parameterized using a categorical distribution; and
the at least one processing device is configured to identify the updated weights for the trained machine learning model based on the initial weights, the one or more previous weight deltas, and the hard-attention mask applied to the one or more additional weight deltas.

15. The electronic device of claim 14, wherein, to identify the hard-attention mask, the at least one processing device is configured to apply multi-layer perceptron (MLP) parameterization to the learnable mask tensor to modify the learnable mask parameters prior to being parameterized using the categorical distribution.

16. The electronic device of claim 14, wherein, to identify the hard-attention mask, the at least one processing device is configured to perform sparsity regularization to reduce a number of non-zero values contained in the hard-attention mask.

17. A method comprising:
obtaining, using at least one processing device of an electronic device, input data associated with a user request for a trained machine learning model;
identifying, using the at least one processing device, one or more customized tokens associated with the input data, the one or more customized tokens associated with one or more of multiple previous concepts learned by the trained machine learning model;
identifying, using the at least one processing device, key, value, and query features based on the input data and the one or more customized tokens;
performing, using the at least one processing device, key-value projection using the key features, the value features, and weights of the trained machine learning model to generate projected features; and
generating, using the at least one processing device, a response to the user request based on the query features and the projected features;
wherein the weights of the trained machine learning model are modified by sequentially teaching the trained machine learning model one or more new concepts over time.

18. The method of claim 17, wherein:
the user request comprises a request to generate an image containing one or more specified contents, the one or more specified contents associated with one or more of the multiple previous concepts learned by the trained machine learning model;
the one or more customized tokens are associated with the one or more of the multiple previous concepts learned by the trained machine learning model; and
the method further comprises generating a new customized token for each of the one or more new concepts.

19. The method of claim 17, further comprising, for each of the one or more new concepts:
obtaining, using the at least one processing device, additional data associated with the new concept for the trained machine learning model;
generating, using the at least one processing device, one or more additional weight deltas based on the additional data; and
identifying, using the at least one processing device, updated weights for the trained machine learning model based on initial weights of the trained machine learning model, one or more previous weight deltas associated with at least one of the multiple previous concepts, and the one or more additional weight deltas.

20. The method of claim 19, further comprising:
deleting the additional data from the electronic device after the one or more additional weight deltas are generated.
